(19) United States
(12) Patent Application Publication
(10) Pub. No.: US 2019/0180209 A1
(43) Pub. Date: Jun. 13, 2019

(54) INTERACTIVE SYSTEM FOR OPTIMIZING LOGISTICS IN MOVING ITEMS FROM A FIRST LOCATION TO SECOND LOCATION

(71) Applicant: Residential Logistics Solutions, LLC, Carrollton, TX (US)

(72) Inventors: Ashraf Syed, Carrollton, TX (US); Reuben Fine, Carrollton, TX (US)

(21) Appl. No.: 15/838,239

(22) Filed: Dec. 11, 2017

(51) Int. Cl. G06Q 10/06; G06Q 50/28

(52) U.S. Cl. CPC G06Q 10/06312; G06Q 50/28

(57) ABSTRACT

A logistics optimization system is described that enables items to be efficiently moved from a first location to a second location. The system optimizes aspects of moving items between locations by enabling a user to monitor and/or control processes including customer management, scheduling, resource allocation and utilization, and cost estimation from a single point within the logistics system. The optimized information can be presented to the user along with interactive tools that allow to evaluate the customer relationship and moving process, make adjustments, provide instructions, and the like throughout the moving process.

### TECHNICAL FIELD

The present disclosure relates to a system for optimizing logistics in moving items from a first location to a second location. Specifically, the present disclosure relates to a system for optimizing aspects of moving items between locations by enabling a user to monitor and/or control processes including customer management, scheduling, resource allocation and utilization, and cost estimation from a single point within the logistics system.

### BACKGROUND OF THE INVENTION

The process of moving personal or business property can be complicated and time consuming. Planning such a move often requires several types of services as well as property inspections to obtain a quote or estimated cost for the move. For example, prior to a move, it can be necessary for an estimator to visit a home or business in order to inspect the items to be moved. In such instances, it can be difficult for the estimator to manually generate a cost estimate, and therefore, the customer can be forced to wait a given time period before obtaining the estimate. Further, because moving companies have quantified resources, a customer can be forced to schedule an inspection several days in advance of the move date. While some moving companies have attempted to simplify the estimate process by prompting the customer to complete online questionnaires and the like, the customer is often forced to wait for an estimate in most cases because the estimate system is not truly automated.

Further, even moving companies that are automated to some extent have no meaningful way optimize their resources for a given move while being able to evaluate job performance and/or customer satisfaction throughout the moving process. As such, the moving process often wastes an appreciable amount of moving company resources and is frustrating to the customer, which naturally leads to lower customer acquisition and retention.

### BRIEF SUMMARY OF THE INVENTION

In view of the foregoing, embodiments described herein provide a logistics optimization system that enables items to be efficiently moved from a first location to a second location. The system optimizes aspects of moving items between locations by enabling a user to monitor and/or control processes including customer management, scheduling, resource allocation and utilization, and cost estimation from a single point within the logistics system. The optimized information can be presented to the user along with interactive tools that allow a user to evaluate the customer relationship and moving process, make adjustments, provide instructions, and the like throughout the moving process.

According to one embodiment a system is described for optimizing logistics in moving a plurality of items from a first location to a second location. The system comprises an estimator module configured to receive data input by an estimator and display at least a portion of estimator-input data to a system management module. The system also comprises a driver module configured to receive data input by a driver and display at least a portion of the driver-input data to the system management module. The system further comprises a customer module configured to receive data input by a customer and display at least a portion of the customer-input data to the system management module. The system management module compares information contained in the estimator-input data, the driver-input data, and the customer-input data to resources available during a time period specified for moving the plurality of items. Based on the comparison, the system management module allocates a subset of the resources available and schedules moving the plurality of items for a certain time within the specified time period. The system management module also displays, to a user of the system management module, the subset of resources allocated to moving the plurality of items, the certain time, and an interactive tool that allows the user to modify at least one of the allocation and the certain time, and provide additional instructions to at least one of the driver, the estimator, and the customer.

The foregoing has outlined rather broadly the features and technical advantages of the present invention in order that the detailed description of the invention that follows can be better understood. Additional features and advantages of the invention will be described hereinafter that form the subject of the claims of the invention. It should be appreciated by those skilled in the art that the concepts and specific embodiments disclosed can be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further benefits and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present invention, reference is now made to the following descriptions taken in conjunction with the accompanying drawings, in which:

FIG. 1 illustrates certain aspects of a moving logistics system according to described embodiments;

FIGS. 2A and 2B illustrate certain aspects of a system management module according to described embodiments;

FIG. 3 illustrates certain aspects of a driver module according to described embodiments;

FIG. 4 illustrates certain aspects of an estimator module according to described embodiments;

FIG. 5 illustrates certain aspects of a customer module according to described embodiments;

FIG. 6 illustrates certain aspects of a logistics module according to described embodiments;

FIG. 7 illustrates a process for estimating a cost of moving items according to described embodiments;

FIG. 8 illustrates a process for optimizing logistics in moving items according to described embodiments;

FIG. 9 illustrates a process for optimizing logistics in moving items according to described embodiments; and

FIG. 10 illustrates a graphical interface for optimizing logistics in moving items according to described embodiments.

### DETAILED DESCRIPTION OF THE INVENTION

Described embodiments provide a comprehensive system that optimizes different aspects of moving items from a first location to a second location. The system leverages one or more communication networks, centralized or distributed nodes across the networks, and mobile applications to enable real-time communication throughout the moving process. At one or more central nodes in the system, a user (e.g., an employee of a moving company) monitor and/or controls various processes including customer management, scheduling, resource allocation and utilization, and cost estimation, employee qualification and hiring, driver performance and guideline compliance, and optimizing logistics for a given move. The optimized information can be presented to the user along with interactive tools that allow the user to evaluate the customer relationship and moving process, make adjustments, provide instructions, and the like throughout the moving process.

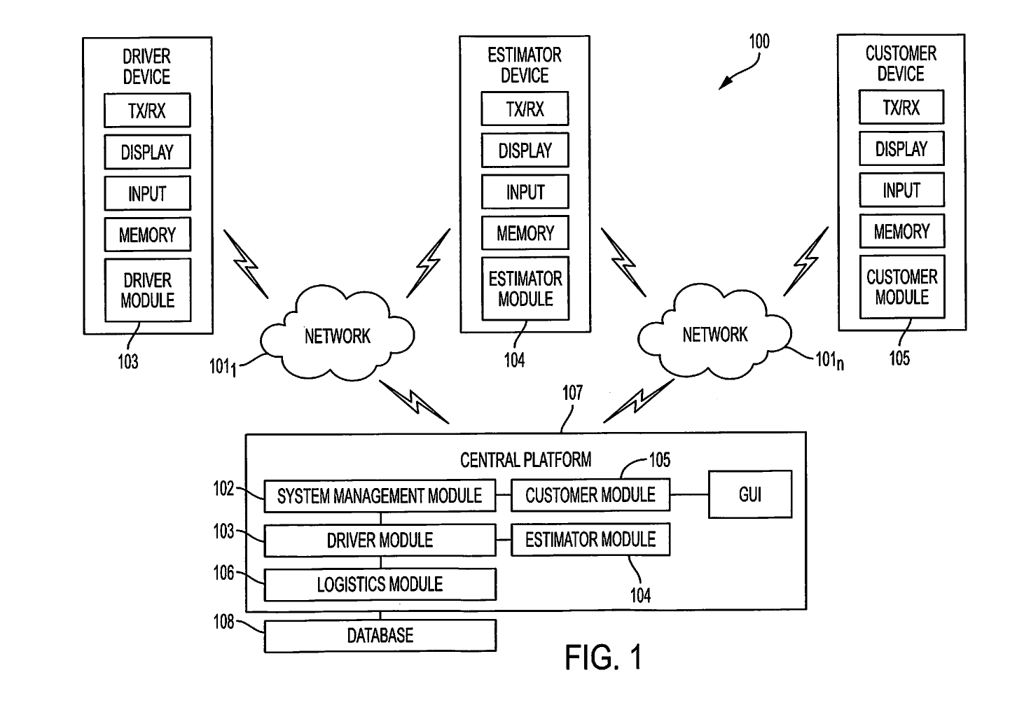

Certain aspects of moving logistics system 100 are illustrated at FIG. 1. As shown, system 100 can be distributed across one or more networks 101₁ . . . 101ₙ and comprises system management module (SMM) 102, driver module 103, customer module 105, estimator module 105, logistics module 106, central platform 107, and database 108.

As discussed herein, system management module 102 allows a user to monitor interactions between a customer and the moving company prior to, during, and after the moving process. Using system management module 102, a potential customer can be classified according to their progression in the moving process, i.e., whether the customer has expressed interest, if a scheduled move has been confirmed, if a follow up action is required for the customer, and the like. System management module 102 also allows a user to monitor various data received from the customer during the process, whether the customer input is received from customer module 105 or other customer-facing module. Also, customer satisfaction during and after the moving process can be evaluated by soliciting customer feedback and responding to same. It naturally follows that system management module 102 can be leveraged to increase customer acquisition and retention.

Drivers are able to communicate with central nodes in or near real-time using driver module 103, instances of which can be implemented at central platform 107 and a driver's tablet or mobile device. This allows adjustments and updates to be made in response to unexpected events or conditions. This also allows a driver to upload pertinent information during the moving process while allowing a user to evaluate performance of the moving team in or near real-time.

More efficient cost estimation is enabled by estimator module 104, instances of which can be implemented at central platform 107 and/or an estimator's mobile device or tablet. In that way, information input from an estimator can be leveraged to efficiently provide a cost estimate. This streamlines the moving process from the outset.

Logistics module 106 leverages information stored at central platform 107 and/or database 108 and various system modules to optimize the manner in which the move is performed. By way of example, moving company resources can be measured against customer requirements, characteristics of a given move, an overall schedule, and the like to ensure that moving company resources are utilized in an optimized manner. As discussed herein, in optimizing the process of moving items between locations, embodiments utilize various inputs to estimate a cost for a planned move and further optimize customer acquisition and retention, resource utilization, and profits for a company responsible for the planned move. This yields meaningful improvements in a moving company's profitability.

Central platform 107 is configured to support system management module 102, as well as implement instances of the other foregoing modules. Platform 107 can function as a centralized resource that allows a user to view information received from, and interact with, other system modules. Accordingly, the user can manage customer relationships prior to, during, and after the move, monitor driver performance and compliance using data received via driver module 103, view information received from an estimator via estimator module 104, view and respond to customer input received via customer module 105, and manage logistics and pricing for a given move using logistics module 106—all at or near real-time. Accordingly, a user can communicate with the many individuals required to ensure that scheduled moves are completed in a timely fashion while company resources are conserved. In this way, logistics are optimized.

A node in system 100 can comprise a smart phone, laptop computer, tablet computer, user terminal and personal computer, among other devices capable of performing functions described herein. Each node can include one or more transmitters and one or more receivers for communicating with other nodes in system 100 via one or more networks 101.

Processors operating at a node can be one or more central processing units (CPUs) for performing functions described herein. A node can include memory in communication with a processor, and a display arranged to display information to a system user (e.g., an estimator, driver, or other employee, as well as a customer).

Each node further comprises an input configured to receive user inputs in the form of, e.g., a keyboard, touch screen keyboard, and/or computer mouse, among other input devices that allow a user to input data related to a move.

Memory within each node can include non-volatile and volatile memory. For example, non-volatile memory can include a hard drive, flash memory, memory stick and the like. Also, volatile memory can include random access memory and other types known in the art. Memory can store program instructions such as those executed by modules described herein. The instructions, when executed, cause the processor to perform the processes described herein.

Further, memory can store user input data such that a node can modify previously-input data dynamically at or near real-time. Alternatively, user input data can be stored at a node or one or more servers and/or databases, such as database 108, utilized by system 100.

Databases 108 can be a structured query language (“SQL”) based database such as a MYSQL database or other type of database known in the art. Database 108 can be distributed or collocated with platform 107, and can store system information such as presets, dynamic thresholds, company-specific information relating to available resources, and the like.

Each network 101 can include an internet protocol (“IP”) network, wireless communication network, cellular communication network and public switched telephone network (“PSTN”), among other types of networks known in the art that can be established as a wide area network (“WAN”) and/or local area network (“LAN”), such as an Ethernet LAN, among other IP-based networks.

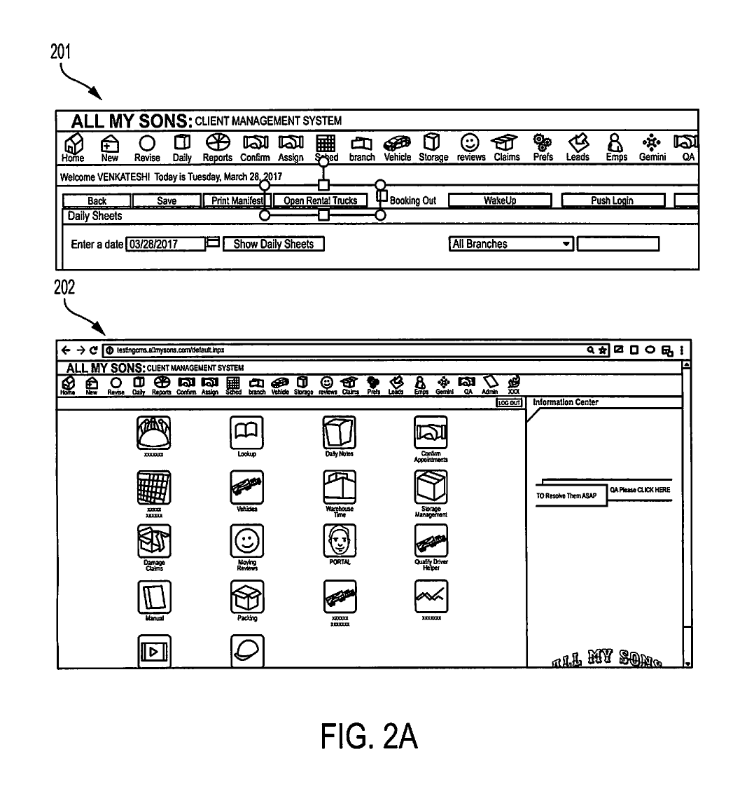

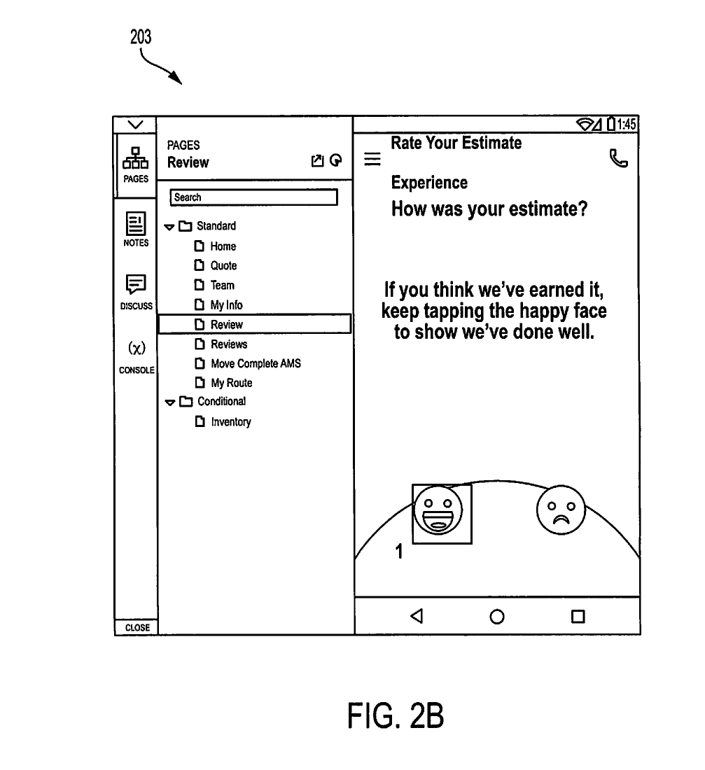

FIGS. 2A and 2B illustrate certain aspects of system management module (SMM) 200. According to an embodiment, SMM 200 corresponds to system management module 102 illustrated in FIG. 1 and can be integrated with other system modules or components, such as those comprising system 100. SMM 200 interfaces with other components or modules of system 100 and comprises a user-facing display. Accordingly, a user (e.g., an employee of a moving company) can evaluate functions performed by system 100 and participate in or otherwise modify those functions as appropriate. SMM 200 also provides automated reminders for different tasks during a move and aggregates and integrates several services within the same platform to enable a user to complete those tasks in a partially or fully automated manner.

SMM 200 also allows a user to interface with vendors. For example, a user can execute a rental for a moving vehicle. Rental vehicles page 201 displays various fields including, e.g., vehicle type and or number, rental company, date needed, expected return, reason needed, agreement #, vehicle #, start miles, finish miles, date returned, total miles, status, approve, save, and save & close for the user to update the details of the request. Using these fields, the user enters appropriate values to execute the vehicle rental. For instance, if the rental is determined to be successful, a user will be prompted to update the agreement/contact number, vehicle number, start miles, finish miles, total miles, return date, and the like. The user can then execute a validation/approval process or transmit a request for validation/approval to another employee with appropriate authority. To ensure the process is completed in a timely manner, notifications are sent periodically until a specified action is either pending or an action has been performed in response to the request.

SMM 200 can also be configured to enable to user to complete a process for hiring a new employee, e.g., a driver or a helper. Within module 200, a user can select qualification page 202 to qualify an employee. The qualification process involves executing a background check, confirming results of a drug test, verifying driver license information, and the like. Once a user is ready with the application of the employee candidate, i.e., after the background check, etc., have been performed, the employee candidate and related information is displayed in a table format and an indication is provided that verification is complete. Once the user finalizes the qualification action, details relating to the employee's status are stored in a database, e.g., database 108.

According to an embodiment, three approval levels are associated with permissions to qualify/disqualify a driver and/or helper: (1) branch manager/administrator, (2) fleet manager, and (3) office manager. In one scenario, each of a branch manager/administer and fleet manager can qualify helpers, only fleet managers can qualify drivers, only branch managers/administrators can disqualify a driver, and an office manager has authority to qualify/disqualify a helper but only disqualify a driver. The user can perform actions according to their role i.e., if the branch administrator or fleet manager is in action, they can qualify/disqualify both a driver and a helper, but if the office manager is in action then he can qualify/disqualify only the helper.

SMM 200 can also be utilized to verify whether a moving company is able to provide moving services on the date indicated by user input data. For example, SMM 200 can store scheduling information for various moves and determine if the moving company is available to service the customer on the date requested by the customer. The service calendar can track availability of equipment and human resources. If SMM 200 determines one or more dates associated with user input data are unavailable, it can prompt the customer to enter new moving dates.

SMM 200 also includes functions that allow users to track a customer's progress in scheduling a move. In doing so, SMM 200 categorizes a customer according to whether the customer has inquired about details such as prices, has met with an estimator, has agreed to sign a contract, and the like. Accordingly, SMM 200 automates reminders for action items that need to be taken to continue to move the customer through the sign up process. Similar reminders can be set up to prompt a user to illicit feedback from the customer once the move has been finished.

Page 203 enables a user to view feedback from one or most customers and an overall rating or score based on customer feedback. Accordingly, a user can leverage this information to determine what, if any, appropriate follow up actions are needed for a given customer. The customer feedback can be expressed in a number of ways to convey a measure of satisfaction among the moving company's customer base.

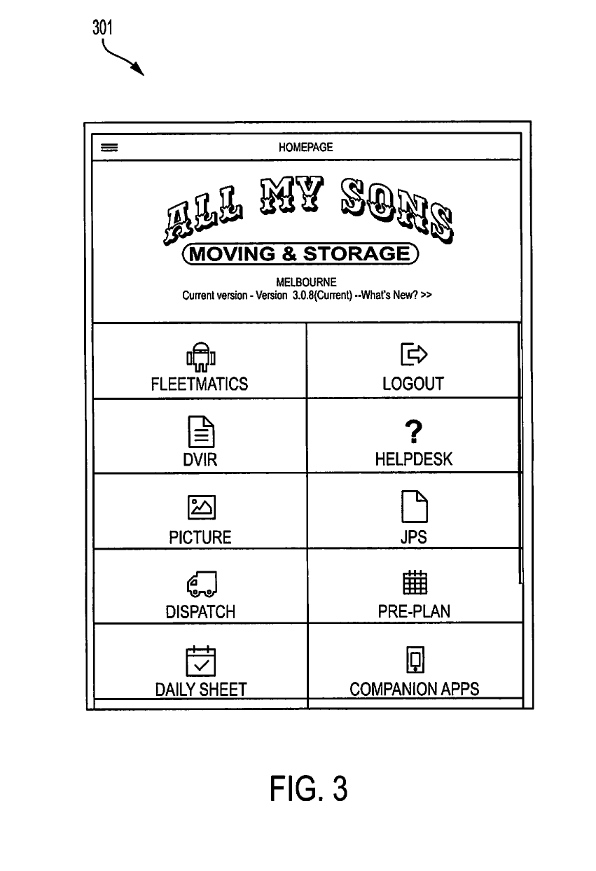

FIG. 3 illustrates certain aspects of driver module 300. According to an embodiment, driver module 300 corresponds to driver module 103 illustrated in FIG. 1 and can be integrated with other system modules or components, such as those comprising system 100. Driver module 300 can be implemented at CMS 102 and, e.g., a tablet or mobile device used by the driver. Module 300 allows a driver to enter data in various fields to, e.g., verify a moving vehicle is inspected prior to a move, obtain verification of move start/stop times, obtain customer verification of the move, record damaged items, and the like.

To utilize module 300, a driver logs on and enters relevant information such as an assigned branch number. A driver can also upload inspection images of the moving vehicle and other pertinent information using, e.g., page 301. According to an embodiment, page 301 displays options including: Fleematics, Logout, DVIR, Helpdesk, Picture, JPS, Dispatch, Pre-Plan, Daily Sheet, and Companion Applications.

Data entered by the driver can be saved to a central database, such as database 108 when module 300 seeks online connectivity for the driver's tablet or mobile device. This is advantageous because, when the driver goes offline, work is temporality saved to the tablet or mobile device. Once module 300 identifies a wireless connection, data is updated to a server or database 108. As will be appreciated, different data synching schemes can be implemented. By way of example, according to one embodiment, when a wireless connection is active, data from module 300 automatically syncs with central platform 107. When a connection is not available, data is locally stored until connectivity is restored.

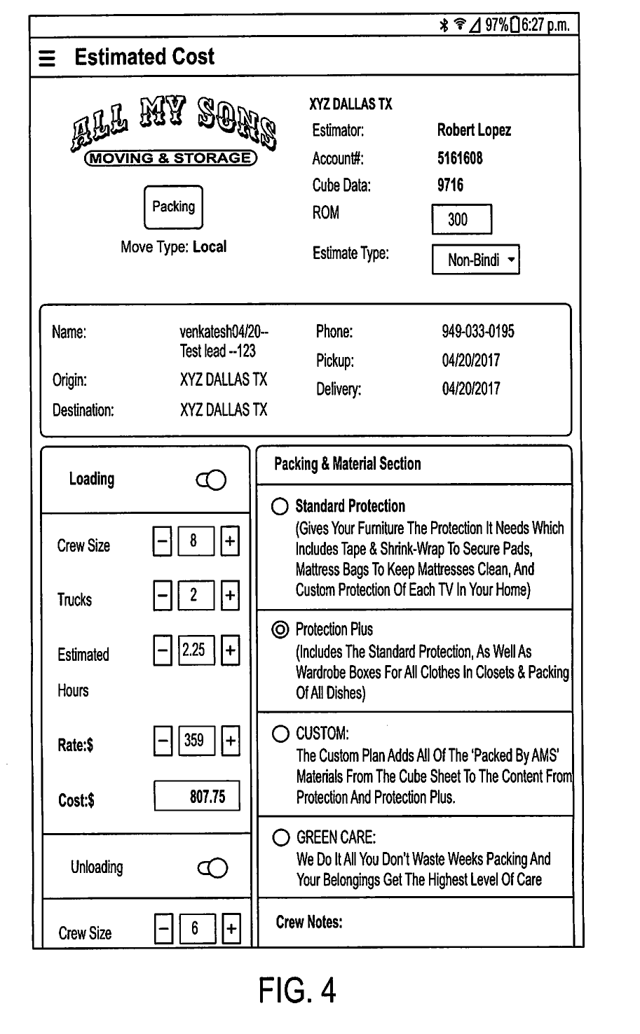

FIG. 4 illustrates certain aspects of estimator module 400. According to an embodiment, estimator module 400 corresponds to estimator module 104 illustrated in FIG. 1 and can be integrated with other system modules or components, such as those comprising system 100. Estimator module 400 can be implemented at CMS 102 and, e.g., a tablet or mobile device used by an estimator. Estimator module 400 is configured to both receive data input by an estimator and present information to the estimator, which can be viewed on a estimator's computer and/or mobile application.

Advantageously, estimator module 400 is configured to adapt to changing industry requirements and improve speed of data entry, thereby allowing an estimator to focus on customers rather than calculating cost, time, and quality of packing—each of which are built-in features of module 400. Module 400 enhances the ability of an estimator to provide a quick and accurate quote to the customer, thereby increasing sales and revenue. An estimator can access and book leads, execute credit card transactions, schedule appointments, and implement prime pricing. An estimator can also use module 400 to perform multiple tasks such as search for customer information, add a new lead, or reset search criteria. Further, an estimator can select customer details from predefined options including customer name, customer contact information, appointment details, pricing information, and the like.

Estimator module 400 receives estimator data to generate a summary of moving details, generate a schedule for the move, estimate costs, and the like, as well as present useful information to the estimator prior to, during, and after the move. This information is displayed on a page or lead details page 401.

Module 400 is configured to receive data input by the estimator associated with moving items and display cost estimates or quotes based on predefined cost data, which can be stored by system 100. The cost estimates can be dynamically updated after at least a portion of the estimator data has been received, i.e., dynamically updated as the estimator enters or modifies data. For example, lead detail page 401 can display updated data to an estimator as estimates are dynamically calculated.

According to an embodiment, lead detail page 401 comprises an origin location field in which an estimator is prompted to enter information associated with a origin location. For example, origin location information can include an address of the location and other features such as the number of building stories, number of elevators available for loading, square footage, distance from the customer's door to an available elevator, etc.

A destination field allows an estimator to enter delivery location information, i.e., data input by the estimator, associated with a delivery location where one or more of the items are to be moved or dropped off. For example, the destination location can be a final destination address where any remaining moved items on a moving vehicle are to be dropped off. The delivery information can include destination location characteristics such as building stories, square footage, number of elevators usable for loading, and the distance from an elevator or stairs to the door. Such information can also be used to estimate moving costs.

Module 400 also includes cube sheet page 402, which can be utilized by an estimator to enter information relating to items that must be moved. Cube sheet page 402 list item attributes, such as name/type of item, size, room corresponding to the item, number of items, packing requirements, etc. Information entered at cube sheet page 402 is summed to determine cube data, which corresponds to size requirement for moving vehicles and packing requirements.

According to an embodiment, using cube sheet page 402 an estimator can, e.g., select furniture items from a drop down menu or drag and drop furniture icons into a predefined box or the like that correspond to items to be moved. The total number of items and item characteristics of the items to be moved are tracked. The estimator can dynamically modify furniture information by modifying the information input at page 402. The number of items and/or item characteristics are used in part to determine total cost. For example, the item characteristics can indicate an estimated weight of an item in which the weight of the item is used in part to determine fuel cost, required vehicle type, number of movers, and the like. In other words, furniture characteristics can be used to determine the number of movers or size of the moving team needed to move the items and an estimated time needed to move each item, i.e., loading/unloading time.

Further, the estimator can select from a variety of additional moving products and/or services such as chandelier removal, curtain removal, furniture disassembly/assembly, window/door removal for oversized items, disassemble/reassemble office partitions, buying moving accessories (boxes, pads, blankets, bubble wrap, paper, popcorn, rolls of corrugated cardboard for floor protection, shrink wrap, etc.), moving specialty items (hot tub, pool table, automobiles, etc.), placing felt on the bottom of furniture and flexible on-site arranging of furniture at a drop off location, among other products and/services.

According to an embodiment, page 402 can include a temporary storage field that prompt the estimator for to request storage facility information, storage room characteristics, and number of items to be stored, among other information associated with temporary storage of moved items that can be used to estimate moving costs. Storage room characteristics can include unit size, floor number, whether air conditioning is provided and square footage, among other information associated with the storage room. Also, the estimator can indicate that no temporary storage information will be entered in which the estimator can later return to update the temporary storage field.

According to another embodiment, page 402 can include an extra stop field that allows the estimator to enter extra stop information, i.e., extra stop data, related to one or more extra stops that are added to the travel path from the origin location to the destination location. In particular, an extra stop can be an additional origin location or delivery location, e.g., second pick-up or delivery location. The extra stop information can include a location address, building characteristics associated with the extra stop, total pieces of furniture to be dropped off or picked up at the extra stop and total boxes to be dropped off or picked up at the extra stop. Extra stop field also displays the extra stop cost estimate that indicates the price associated the extra stop.

According to another embodiment, page 402 can include company assistance field 407 that allows the estimator to enter information related to company packing and/or unpacking services. For example, the estimator can indicate that one or more items are to be packed by the company in which the estimator indicates the tier of service, the amount of boxes needed to pack the items. and specialized instructions. The estimator can also indicate the amount of boxes that need to be unpacked by the company and the like.

Estimate page 403 presents cube data, crew and vehicle requirements, loading/unloading requirements, packaging specifications, purchased coverage and protection plans, crew notes, cost, payment methods, and the like. Page 403 can also include a broken-out estimated cost associated with packing and/or unpacking by the company, e.g., such that the estimator can modify or adjust the data input by the estimator associated with company-assisted packing to suit the customer's needs and budget.

Each page in module 400 allows the estimator to change or modify information as required without having to re-enter previously-entered data input by the estimator, e.g., the estimator can change origin location characteristics without having to re-enter address information.

According to an embodiment, estimator module 400 can be configured to print and/or generate a printable estimate sheet with information for the move based on the various cost estimates and data input by the estimator and/or received from the customer from customer module 500. For example, the estimate sheet can include items to be moved, pick-up/delivery locations, number of movers, number of and type of moving vehicle, payment terms, company contact information and notices, among other information. The printable estimate sheet provides the customer with a written version of information and reduces ambiguity as to the terms and conditions for the move. The format of the printable estimate sheet can be dynamically reconfigured by the moving company as needed.

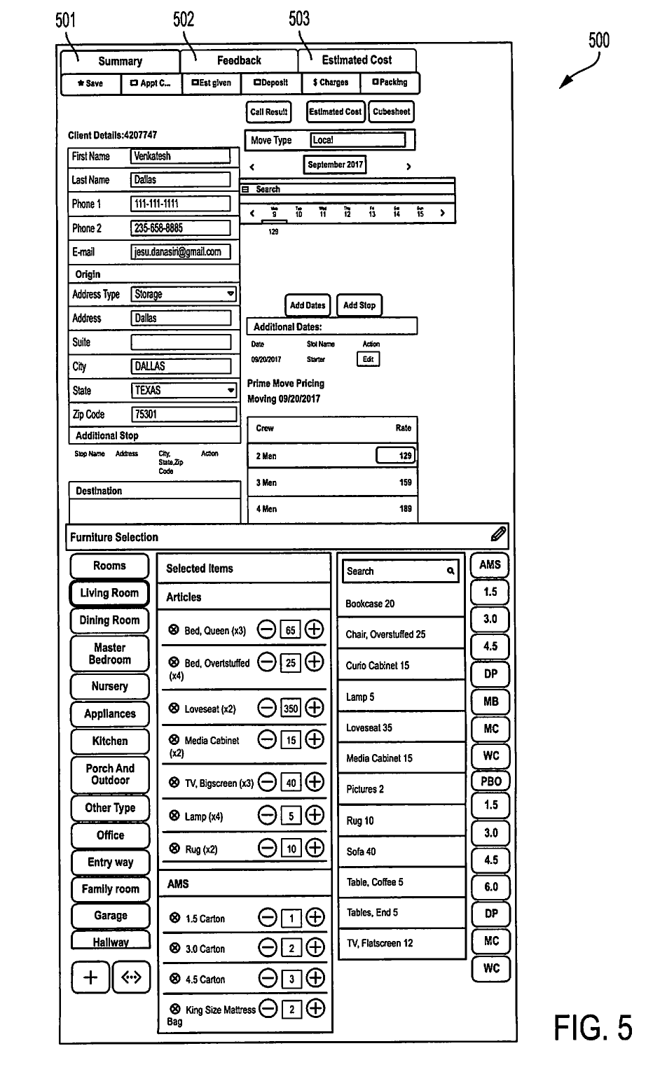

FIG. 5 illustrates certain aspects of customer module 500. According to an embodiment, customer module 500 corresponds to customer module 105 illustrated in FIG. 1 and can be integrated with other system modules or components, such as those comprising system 100. Customer module 500 is configured to both receive data input by a customer and present information to the customer. By way of example, customer module 500, as described herein, receives customer data to generate a summary of moving details, generate a schedule for the move, estimate costs, and the like, as well as present useful information to the customer prior to, during, and after the move.

Customer module 500 can be viewed on a customer's computer and/or mobile application. Module 500 is configured to receive data input by the customer associated with moving items and display cost estimates or quotes based on predefined cost data, which can be stored by system 100. The cost estimates can be dynamically updated after at least a portion of the customer data has been received, i.e., dynamically updated as the customer enters or modifies data. For example, summary page 501 can display updated data to a customer as estimates are dynamically calculated. In this way, summary page 501 summarizes information input by the customer and allows the customer to change or modify information without having to re-enter previously entered data, e.g., the customer can change pick-up location characteristics without having to re-enter address information.

According to an embodiment, summary page 501 comprises a pick-up or origin information field in which a customer is prompted to enter information associated with a pick-up location. For example, pick-up location information can include an address of the location and other features such as the number of building stories, if elevators are available for loading, square footage, distance from the customer's door to an available elevator, etc.

Summary page 501 also allows customer to enter destination information. For example, the destination location can be a final destination address where any remaining moved items on a moving vehicle are to be dropped off. The destination information can include destination location characteristics such as building stories, square footage, elevators usable for loading, and the distance from elevator or stairs to the door, all of which can be used to estimate moving costs.

According to an embodiment, page 501 can include a temporary storage field that prompts the customer for storage facility information, storage room characteristics and number of items to be stored, among other information associated with temporary storage of moved items that can be used to estimate moving costs. Storage room characteristics can include unit size, floor number, whether air conditioning is provided and square footage, among other information associated with the storage room. Also, the customer can indicate that no temporary storage information will be entered in which the customer can later return to update the temporary storage field.

According to another embodiment, page 501 can include an extra stop field that allows the customer to enter extra stop information, i.e., extra stop data, related to one or more extra stops that are added to the travel path from the pick-up location to the delivery location. In particular, an extra stop can be an additional pick-up location or delivery location, e.g., second pick-up or delivery location. The extra stop information can include a location address, building characteristics associated with the extra stop, total pieces of furniture to be dropped off or picked up at the extra stop and total boxes to be dropped off or picked up at the extra stop, among other information associated with the one or more extra stops that can be used to calculate the extra stop cost estimate. The extra stop field also displays the extra stop cost estimate that indicates the price associated the extra stop.

Summary page 501 also allows a customer to input furniture information. According to an embodiment, a customer can, e.g., drag and drop furniture icons or select furniture items from a drop down menu that correspond to items to be moved into a predefined box or the like, such that the total number of items and item characteristics can be dynamically updated. The customer can also dynamically update the furniture information by modifying the information input at page 501.

The number of items and/or item characteristics are used in part to determine total cost. For example, the item characteristics can indicate an estimated weight of an item in which the weight of the item is used in part to determine fuel cost, required vehicle type, number of movers, and the like. In other words, the pick-up location characteristics can be used to determine the number of movers or size of the moving team needed to move the items and an estimated time needed to move each item, i.e., loading/unloading time. Further, the customer can select from a variety of additional moving products and/or services such as fixture removal, furniture disassembly and/or assembly, oversized items, moving accessories, specialty items, among other products and/services.

According to another embodiment, page 501 can include a company assistance field that allows the customer to enter information related to company packing and/or unpacking services. For example, the customer can indicate that one or more items are to be packed by the company in which the customer indicates the amount of boxes needed to pack the items. The customer can also indicate the amount of boxes that need to be unpacked by the company.

Customer module 500 can include feedback page 502 that allows a customer to provide feedback by clicking on icons, typing messages, posting reviews, and the like. A customer can select various options to indicate if the moving crew was friendly, timely, and behaved in a professional manner. A customer can also enter data to prompt a follow up phone call or request another action. Customer module 503 can also include estimated cost 503 page which, as discussed herein, allows a customer to view the estimated cost as it is dynamically updated according to information provided iteratively provided at pages 501 and 502.

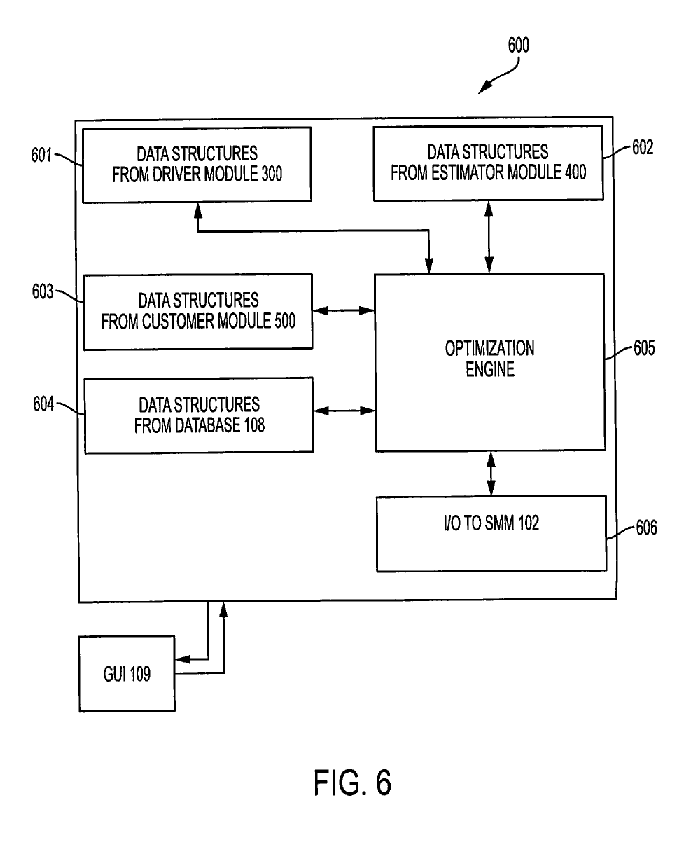

FIG. 6 illustrates certain aspects of logistics module 600. According to an embodiment, logistics module 600 corresponds to logistics module 106 illustrated in FIG. 1 and can be integrated with other system modules or components, such as those comprising system 100. Logistics module 600 can receive data structures comprising data related to a to-be scheduled move from various systems components. As discussed herein, examples of such data includes move date, origin location, destination location, geographical and/or map data, proposed move dates, number and size of items to be moved, and the like.

According to the illustrated embodiment, logistics module 600 compiles data structures received from driver module 300 (input 601), estimator module 400 (input 602), and/or customer module 500 (input 603) and calls data structures relating to company resources stored at, e.g., database 108 (input 604). Logistics module 106 utilizes these data structures and operates to ensure the cost estimate provided to a customer is both fair to the customer and profitable for the company. Logistics module 106 also utilizes the data structures to determine how company resources should be allocated in a most efficient manner while satisfying profitability conditions, and output logistics information, including price and profitability data, to a user. These functions are performed by optimization engine 605. Optimization engine 605 transmits and receives data structures corresponding to logistics/optimization information to SMM 102 and receives user feedback therefrom (I/O 606). The user interactively provides feedback to SMM 102 (and ultimately updates optimization engine 605 with new instructions, new rules, new information relating to available resources and the like) using GUI 109.

Logistics module 600 combines and/or overlays data received from the driver via drive module 300, the estimator via estimator module 400 and/or data received from the customer via customer module 500 with data, rules, thresholds and the like provided by SMM 102 to estimate a total cost and optimize company resources. In other words, logistic module 600 compiles data structures received by other system modules with predefined data, e.g., company resources stored in database 108, associated with a moving company to derive requirements for a planned move. As discussed herein, these requirements are optimized to minimize moving company resources while maximizing scheduling efficiency and the like. This information is presented to the user via, e.g., GUI 109, such that a user can view dynamically-changing data, as well as constant or near-constant data (such as fuel prices, hourly wages, etc.), to make faster and more informed decisions about the utilization of company resources.

Accordingly, during operation, logistics module 600 includes a summary of logistics based data structures received from driver module 300, estimator module 400, customer module 500, and/or SMM 102. The summary of logistics can include a load time, travel time, number of required movers, hourly rate for movers (labor rate), vehicle type and hourly vehicle rate, among other information. The user can modify or change the location information in order to manipulate the cost of the move.

For example, the user can remove an extra stop in order to bring the cost down. Module 600 can also include total inventory cost section 602 that displays the total cost associated with individual items to be moved. The individual inventory cost associated with each item is predefined or predetermined by the moving company, but can be dynamically updated by the moving company.

Logistics module 600 can also combine two or more scheduled moves to minimize company resources required to complete both moves. This can be based on, e.g., an expected profit margin for each move, location of the moves, resource utilization, and number of items being moved. Again, these operations could be performed by optimization engine 605. By combining moves in certain instances, a moving company can most efficiently utilize moving vehicles and employees.

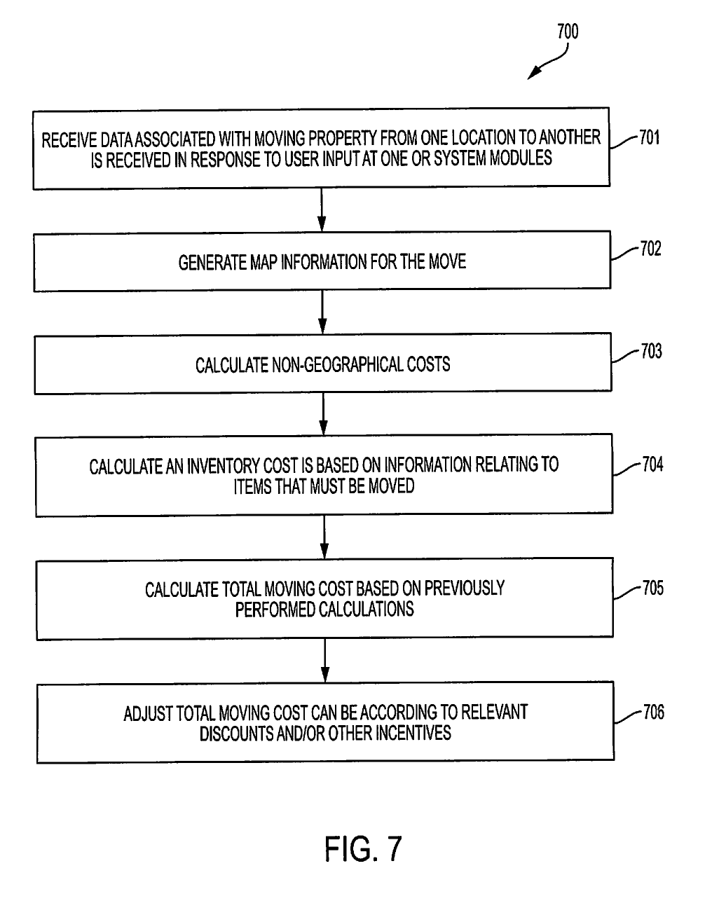

FIG. 7 illustrates an exemplary method for interactively estimating a cost of moving items from a first location to a second location and optimizing logistics to effectuate the move according to aspects of described embodiments. Steps shown in FIG. 7 can be executed by certain components of system 100 illustrated at FIG. 1. For instance, according to one implementation, the steps can be executed SMM 102, which itself can call or otherwise utilize data it receives from other modules. Accordingly, the cost estimate can be derived from (1) information received from a customer via, e.g., customer module 500, (2) information received from an estimator via, e.g., estimator module 400, (3) information received from a driver via, e.g., driver module 300, and/or (4) information stored at one or more central nodes in system 100, depending on the specific implementation of the inventive concepts. As discussed, instances of modules comprising systems according to inventive concepts can be executed on one or more nodes or devices within the systems and function as inputs to other modules.

At step 701, data associated with moving property from one location to another is received in response to user input at one or system modules, e.g., a customer module or estimator module. Data received at step 701 can comprise, e.g., pick-up location data, delivery location data, distance or map data, and the like. Also, the received data can comprise an indication of extra locations or stops that are necessary between the pickup and delivery location. Ultimately, the data received at step 701 is entered as one or more data fields utilized by the cost module to calculate a total cost.

At step 702, map information can be generated for the move. A geographical map of the locations and travel path corresponding to the user input data, e.g., pick-up location, delivery location, extra stop location, temporary storage location and the travel path between these locations are mapped. In executing the step, an estimator module can utilize third party mapping software, where it populates the software with necessary address information. Route information can be centrally stored and later retrieved by, e.g., a driver module to ensure all employees are in agreement as to routing information and the like.

At step 703, non-geographical costs are calculated. By way of example, in response to user input, a determination is made if a customer requires packing/unpacking services, a quantify of boxes and packing material required by the customer, additional costs such as toll fees, and the like can be calculated. By way of further example, a determination can be made if a moving vehicle required to move the items is too large to reach the pick-up, delivery, and/or extra stop locations based on user input data. If the moving vehicle is too large, a prompt can be transmitted to the user to suggest use of a smaller vehicle. The smaller vehicle can then be used to move items to/from the moving vehicle, i.e., to shuttle items to/from the larger vehicle. In one embodiment, the determination if the moving vehicle is too large can be based on geographical mapping data or in response to user preference information. The cost can be dynamically updated in real-time to reflect the additional charge associated with changing vehicles.

The cost of insurance coverage can also be included as a data field for calculating a moving cost. A estimator module can interface with insurance providers and download data associated with cost of insurance in order to calculate the insurance coverage charge. Again, the cost can be dynamically updated based on the calculated insurance coverage cost. This data is also entered as one or more data fields utilized by the cost module to calculate a total cost.

At step 704, an inventory cost is calculated based on information relating to the items that must be moved. For example, the inventory cost is based on the type and number of items marked on, e.g. a cube sheet by an estimator or otherwise provided by a customer.

The calculated inventory cost can be adjusted where, e.g., overweight charge is required for items exceeding a predefined weight threshold. This can include an additional charge for moves involving excessive labor as predefined by the moving company. The total moving charge can be updated in real-time based on such additional charges. Inventory cost is also entered as one or more data fields utilized by the cost module to calculate a total cost.

At step 705, a total moving cost is calculated based on the previously performed calculations. Further, the total moving cost can be dynamically updated based on user data that is received after a respective step has been performed. This can happen when, e.g., a user modifies the previously input information to customize the cost and services to the user's needs and budget.

At step 706, the total moving cost can be adjusted according to relevant discounts and/or other incentives. A moving company can offer the customer a discount to in exchange for executing an agreement with the moving company. The incentive can be based upon data input by the customer such as the size of the move, required supplies, and/or other factors. Similarly, for other services such as door removal, furniture wrapping and packing, discounts can be offered to the customer.

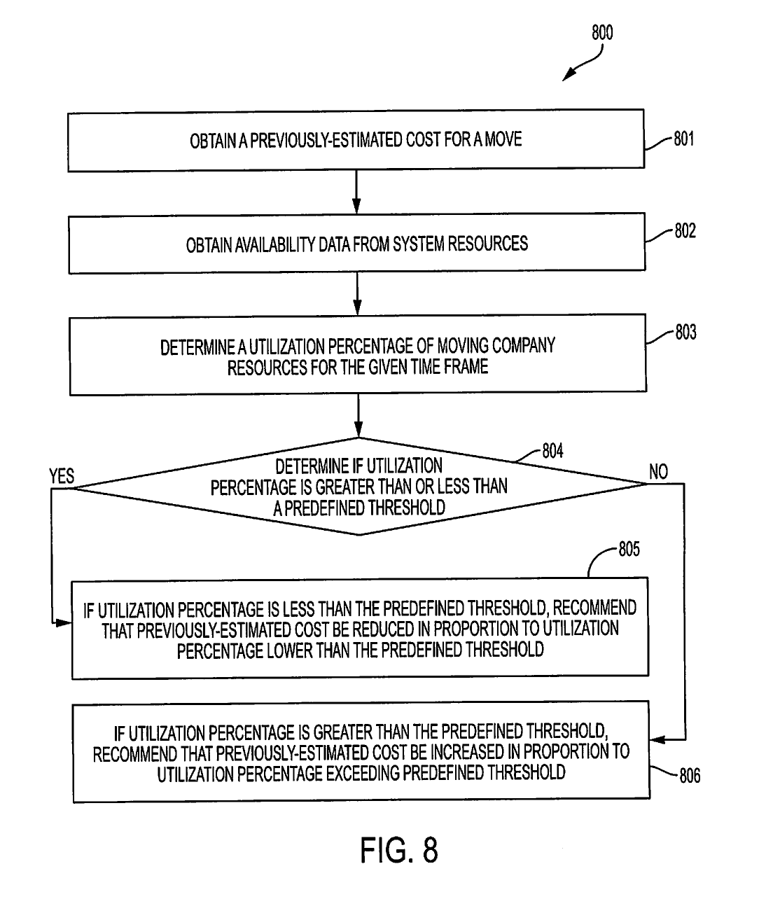

FIG. 8 illustrates an exemplary method for interactively estimating a cost of moving items from a first location to a second location and optimizing logistics to effectuate the move according to aspects of described embodiments. As discussed, optimizing logistics of a given move can comprise minimizing company resources in completing the move in a manner that is satisfactory to the customer. According to an embodiment, steps shown in FIG. 8 can be executed by certain components of system 100 illustrated at FIG. 1. For instance, according to one implementation, the steps can be executed by SMM 102 and/or logistics module 600, which can call or otherwise utilize data they receive from other modules. Accordingly, logistics can be optimized using (1) information received from a customer via, e.g., customer module 500, (2) information received from an estimator via, e.g., estimator module 400, (3) information received from a driver via, e.g., driver module 300, and/or (4) information stored at one or more central nodes in system 100, depending on the specific implementation of the inventive concepts. As discussed, instances of modules comprising systems according to inventive concepts can be executed on one or more nodes or devices within the systems and function as inputs to other modules.

It should be appreciated that logistics can be considered optimized based, in part, on the total moving cost and/or expected profit margin calculated according to, e.g., the process illustrated at FIG. 7. Accordingly, at step 801, an estimated cost for a move is obtained.

At step 802, availability data is retrieved from system resources, such as SMM 200. Such availability data can indicate if moving resources such as moving vehicles, laborers, shipping containers, etc., are available for use during the time frame of the move.

At step 803, a utilization of moving company resources is determine for the given time frame. By way of example, it can be determined that only certain moving vehicles are available for use during the time frame and/or an overall utilization can be calculated. This can be expressed as a percentage of total utilization. Other calculations can be performed with respect to other resources, such as laborers, shipping containers, etc. The utilization and/or availability of certain resources can also be prioritized.

At step 804, a determination is made if resource utilization percentage is greater than or less than a predefined threshold.

At step 805, if a determination is made that resource utilization is less than the predefined threshold, one or more steps can be suggested to a user. For example, the estimated cost presented to a customer can be reduced in proportion to the amount by which utilization is below the predefined threshold. That is, according to an embodiment, as resource utilization percentage decreases, the moving cost presented to the user can be reduced in proportion to the decreased utilization. In other words, by reducing cost presented to the customer the moving company entices a customer to utilize the moving company during periods of decreased utilization. In this scenario, an offset in moving cost to the customer is made for the sake of increasing utilization of company resources, thereby increasing the moving company's revenue. That is, if utilization percentage is less than the predefined threshold, a recommendation is made that previously-estimated cost be reduced in proportion to utilization percentage lower than the predefined threshold.

At step 806, if a determination is made that resource utilization is greater than the predefined threshold, one or more other steps can be suggested to a user. During periods of high resource utilization a logistics module can increase the estimated cost. If a determination is made that resource utilization meets or exceeds the predefined threshold, the moving cost presented to the user can be increased in proportion to the amount the threshold is exceeded. That is, if utilization percentage is greater than the predefined threshold, a recommendation is made that the previously-estimated cost be increased in proportion to utilization percentage exceeding predefined threshold.

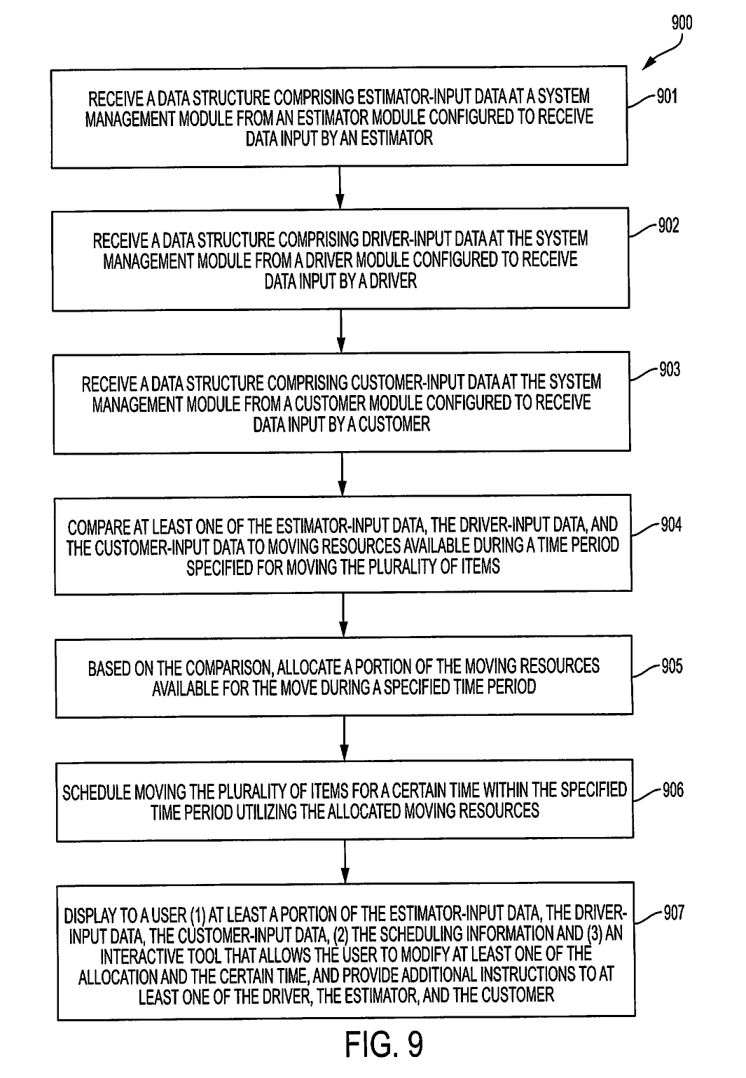

FIG. 9 illustrates an exemplary method for interactively estimating a cost of moving items from a first location to a second location and optimizing logistics to effectuate the move according to aspects of described embodiments. At step 901, a data structure comprising estimator-input data is received at a system management module from an estimator module configured to receive data input by an estimator. At step 902, a data structure comprising driver-input data is received at the system management module from a driver module configured to receive data input by a driver. At step 903, a data structure comprising customer-input data is received at the system management module from a customer module configured to received data input by a customer.

At step 904, at least one of the estimator-input data, the driver-input data, and the customer-input data is compared to moving resources available during a time period specified for moving the plurality of items. Based on the comparison, at step 905 a portion of the moving resources available is allocated for the move during the specified time period. At step 906, moving the plurality of items is scheduled for a certain time within the specified time period utilizing the allocated moving resources.

At step 907, at least a portion of the estimator-input data, the driver-input data, the customer-input data is displayed to a user. Also, an output from the scheduling information is displayed. Advantageously, an interactive tool that allows the user to modify at least one of the allocation and the certain time, and provide additional instructions to at least one of the driver, the estimator, and the customer is also displayed.

Further, steps shown in FIG. 9 can be executed by certain components of system 100 illustrated at FIG. 1. For instance, according to one implementation, the steps can be executed SMM 102, which itself can call or otherwise utilize data it receives from other modules. Accordingly, the cost estimate can be derived from (1) information received from a customer via, e.g., customer module 500, (2) information received from an estimator via, e.g., estimator module 400, (3) information received from a driver via, e.g., driver module 300, and/or (4) information stored at one or more central nodes in system 100, depending on the specific implementation of the inventive concepts. As discussed, instances of modules comprising systems according to inventive concepts can be executed on one or more nodes or devices within the systems and function as inputs to other modules.

For example, utilizing system 100 to perform the foregoing processes illustrated at, e.g., FIGS. 7-9, modules function to allow a user to more quickly and accurately optimize a move. In one instance, an estimator module 104 is configured to receive data input by an estimator and transmit a data structure comprising estimator-input data to system management module 102. Driver module 103 is configured to receive data input by a driver and transmit a data structure comprising driver-input data to system management module 102. Customer module 105 configured to receive data input by a customer and transmit a data structure comprising customer-input data to system management module 102.

Logistics module 106 compares at least one of the estimator-input data, the driver-input data, and the customer-input data to moving resources available during a time period specified for moving the plurality of items, which can be stored at database 108 and/or SMM 102. Based on the comparison, logistics module 106 allocates a portion of the moving resources available, and schedules moving the plurality of items for a certain time within the specified time period utilizing the allocated moving resources.

In view of the foregoing, data can be interactively displayed to a user using a graphical interface having certain sections that dynamically update to represent, e.g., estimator-input data, customer-input data, driver-input data, changing resource data, and the like. The interface can also have sections that represent constant or near-constant data fields. Accordingly, the display and associated methods described herein provide a user with certain advantages over known systems. This allows a user to view updated information and take action based on those updates to quickly and efficiently optimize how a given move is performed between one or more locations.

Advantageously, GUI 109, which can be located with or part of system management module 102, displays various data to a user and allows the user to interact with system 100 to further optimize logistics of a scheduled move. In doing so, GUI 109 can display at least a portion of the estimator-input data, the driver-input data, the customer-input data, as well as an output from logistics module 106. The interactive tool displayed by GUI 109 allows the user to modify at least one of the allocation and the certain time, and provide additional instructions to at least one of the driver, the estimator, and the customer. Further, GUI 109 allows the user to leverage the processes illustrated at, e.g., FIGS. 7 and 8 to manipulate estimated cost and the like to maximize profits for the moving company.

It should be appreciated that a graphical user interface such as, e.g., GUI 109, provides several advantages not available with known systems. A GUI according to embodiments can provide a dynamic display of company resources, where the display is updated as resources are committed to other moves for a given time period, as well as static display such as constant or near constant values, e.g., fuel prices, vehicle rentals, employee wages, and the like. The dynamic information is displayed along with the static information and the system pairs or allocates sets of moving company resources with static information to ensure that company resources dedicated to a move are minimized in terms of costs and, preferably, in a manner that maximized profitability while satisfying customer demands.

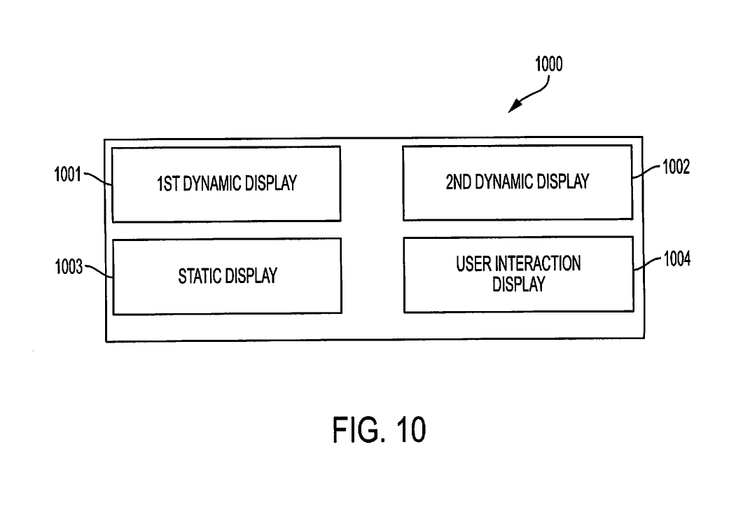

Consistent with the foregoing description, referring to FIG. 10, graphical user interface 1000 has a first display region 1001 for dynamically displaying types and quantity of company resources available during a predefined time period, where each type of company resource corresponds to a quantity and type available for the predefined time period. GUI 1000 also has second display region 1002 for dynamically displaying data corresponding to data structures from at least one of an estimator module, a customer module, and a driver module. GUI 1000 also has third display region 1003 for statically displaying constant or near constant data. Such data can be associated with the dynamically displayed types of company resources and dynamically displayed data received from at least one of an estimator module, a customer module, and a driver module. Such data can include fuel price, number of available trucks, number of available drivers, number pick up/destination features, map information, and the like. GUI 1004 also has fourth display region 10004 for user interaction, which itself can include a plurality of fields for receiving user commands to change at least one of move date and resource allocation, transmit instructions at least one of the driver, estimator, and customer, and the like. This can be done to save time during the moving process, increase profitability, ensure resources are adequately distributed across different moves, and so on.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A system for optimizing logistics in moving a plurality of items from a first location to a second location, the system comprising:
an estimator module configured to receive data input by an estimator and transmit a data structure comprising estimator-input data to a system management module;
a driver module configured to receive data input by a driver and transmit a data structure comprising driver-input data to the system management module;
a customer module configured to receive data input by a customer and transmit a data structure comprising customer-input data to the system management module;
a logistics module that compares at least one of the estimator-input data, the driver-input data, and the customer-input data to moving resources available during a time period specified for moving the plurality of items, allocates, based on the comparison, a portion of the moving resources available, and schedules moving the plurality of items for a certain time within the specified time period utilizing the allocated moving resources;
where the system management module displays, to a system user:
at least a portion of the estimator-input data, the driver-input data, the customer-input data,
an output from the logistics module, and
an interactive tool that allows the user to modify at least one of the allocation and the certain time, and provide additional instructions to at least one of the driver, the estimator, and the customer.

2. A method for optimizing logistics in moving a plurality of items from a first location to a second location, the system comprising:
receiving, from an estimator module configured to receive data input by an estimator, a data structure comprising estimator-input data to a system management module;
receiving, from a driver module configured to receive data input by a driver, data structure comprising driver-input data to the system management module;
receiving, from a customer module configured to receive data input by a customer, a data structure comprising customer-input data to the system management module;
comparing, at a logistics module, at least one of the estimator-input data, the driver-input data, and the customer-input data to moving resources available during a time period specified for moving the plurality of items, allocates, based on the comparison, a portion of the moving resources available, and schedules moving the plurality of items for a certain time within the specified time period utilizing the allocated moving resources;
displaying, at the system management module, to a system user:
at least a portion of the estimator-input data, the driver-input data, the customer-input data,
an output from the logistics module, and
an interactive tool that allows the user to modify at least one of the allocation and the certain time, and provide additional instructions to at least one of the driver, the estimator, and the customer.

3. A graphical user interface for optimizing logistics in moving a plurality of items from a first location to a second location, the graphical user interface comprising:
a first display region for dynamically displaying types and quantity of company resources available during a predefined time period, each type of company resources corresponding to a quantity and type available for the predefined time period;
a second display region for dynamically displaying data corresponding to data structures from at least one of an estimator module, a customer module, and a driver module;
a third display region for displaying constant or near constant data associated with the dynamically displayed types of company resources and dynamically displayed data received from at least one of an estimator module, a customer module, and a driver module;
a fourth display region for displaying an instruction entry region comprising a plurality of locations for receiving user commands to change at least one of move date and resource allocation, and transmit instructions at least one of the driver, estimator, and customer.

4. The system of claim 1 where the system management module estimates a cost of moving the plurality of items; and
the interactive tool allows the user to view and modify data fields upon which the estimated cost is based.

5. The system of claim 4 where the system management module:
dynamically estimates the cost of moving the plurality of items based on a first data set, the first data set comprising:
first data associated with moving the plurality of received from at least one of the estimator module or customer module,
first map information generated for moving the plurality of items,
first non-geographical information, and
a first inventory cost; and
displays the estimated cost of moving the plurality of items to the user via the interactive tool.

6. The system of claim 5 where the system management module:
dynamically updates the cost of moving the plurality of items based on a second data set, the second data set comprising at least one of:
second data associated with moving the plurality of received from at least one of the estimator module or customer module,
second map information generated for moving the plurality of items,
second non-geographical information, and
a second inventory cost; and
displays the updated cost of moving the plurality of items to the user via the interactive tool.

7. The system of claim 4 where the system management module:
optimizes the estimated cost of moving the plurality of items based on a first data set, the optimizing comprising:
determining if a moving company resource utilization exceeds a threshold; and
if the moving company resource utilization does not exceed the threshold, displaying a reduced cost of moving the plurality of items to the user via the interactive tool in proportion to the amount the determined resource utilization is below the threshold, and if the moving company resource utilization does exceed the threshold, displaying an increased cost of moving the plurality of items to the user via the interactive tool in proportion to the amount the determined resource utilization exceeds the threshold.

8. The method of claim 2 further comprising:
displaying, at the system management module, to the system user an estimated cost of moving the plurality of items; and
the interactive tool allows the user to view and modify data fields upon which the estimated cost is based.

9. The method of claim 8 further comprising
dynamically estimating the cost of moving the plurality of items based on a first data set, the first data set comprising:
first data associated with moving the plurality of received from at least one of the estimator module or customer module,
first map information generated for moving the plurality of items,
first non-geographical information, and
a first inventory cost; and
displaying the estimated cost of moving the plurality of items to the user via the interactive tool.

10. The method of claim 9 further comprising
dynamically updating the cost of moving the plurality of items based on a second data set, the second data set comprising at least one of:
second data associated with moving the plurality of received from at least one of the estimator module or customer module,
second map information generated for moving the plurality of items,
second non-geographical information, and
a second inventory cost; and
displaying the updated cost of moving the plurality of items to the user via the interactive tool.

11. The method of claim 8 where the system management module:
optimizing the estimated cost of moving the plurality of items based on a first data set, the optimizing comprising:
determining if a moving company resource utilization exceeds a threshold; and
if the moving company resource utilization does not exceed the threshold, displaying a reduced cost of moving the plurality of items to the user via the interactive tool in proportion to the amount the determined resource utilization is below the threshold, and if the moving company resource utilization does exceed the threshold, displaying an increased cost of moving the plurality of items to the user via the interactive tool in proportion to the amount the determined resource utilization exceeds the threshold.

12. The graphical user interface of claim 2 further comprising:
a fifth display region for displaying a dynamically estimated cost of moving the plurality of items based on a first data set and data fields upon which the estimated cost is based.

13. The graphical user interface of claim 12 further comprising:
a sixth display region for displaying a dynamically updated cost of moving the plurality of items based on a second data set.

14. The graphical user interface of claim 13 further comprising:
a seventh display region for displaying an optimized cost of moving the plurality of items, a threshold, and an indication of whether or not a moving company resource utilization does exceeds the threshold.

15. The graphical user interface of claim 14 where,
if the moving company resource utilization does not exceed the threshold, the seventh display region displays a reduced cost of moving the plurality of items to the user in proportion to the amount the determined resource utilization is below the threshold; and
if the moving company resource utilization does exceed the threshold, the seventh display region displays an increased cost of moving the plurality of items to the user in proportion to the amount the determined resource utilization exceeds the threshold.
